(19) United States
(12) Patent Application Publication
(10) Pub. No.: US 2016/0260594 A1
(43) Pub. Date: Sep. 8, 2016

(54) Sample Inlet and Vacuum System for Portable Mass Spectrometer

(71) Applicant: Paul I. Hendricks, Los Gatos, CA (US)

(72) Inventor: Paul I. Hendricks, Los Gatos, CA (US)

(73) Assignee: BAYSPEC, INC., San Jose, CA (US)

(21) Appl. No.: 14/677,996

(22) Filed: Apr. 3, 2015

Related U.S. Application Data
(60) Provisional application No. 62/127,252, filed on Mar. 2, 2015.

(51) Int. Cl. H01J 49/00; H01J 49/04; H01J 49/06; H01J 49/24

(52) U.S. Cl. CPC H01J 49/0022; H01J 49/24; H01J 49/0495; H01J 49/061

(57) ABSTRACT

An inlet and vacuum system for a portable, or handheld, mass spectrometer. The mass spectrometer comprises three vacuum chambers, which includes two ion funnels connected in series in the first two vacuum chambers, followed by a mass spectrometer analyzer and ion detector in the third vacuum chamber. The ion funnels are arranged with their central axes aligned in a linear fashion. The sample inlet to the portable mass spectrometer is from an external ion source, typically operating at atmospheric, or near atmospheric, pressure. An improvement in desolvation, and a reduction in the injection of neutrals, excited state molecules, and particulates into the analyzer is achieved by incorporating a lateral offset for the inlet capillary used to transfer ions into the first injection funnel. Additional efficiency for ion focusing is achieved by replacing the ion guide, typically used with atmospheric pressure ionization sources, with an additional ion funnel.

### CROSS-REFERENCE TO RELATED APPLICATIONS

This application claims the benefit of U.S. Provisional Patent Application No. 62/127,252, filed Mar. 2, 2015, by Paul I. Hendricks, and titled SAMPLE INLET AND VACUUM SYSTEM FOR PORTABLE MASS SPECTROMETER.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD OF THE INVENTION

The invention relates generally to the field of mass spectrometry, and specifically to an ion focusing and vacuum system for a portable or handheld mass spectrometer, when sampling ions from atmospheric, or near atmospheric, pressures.

### BACKGROUND OF THE INVENTION

The practice of mass spectrometry involves the manipulation and control of charged particles of a substance to determine the mass-to-charge ratio, the chemical formula, the chemical structure, the isotopic ratio, the relative concentration and the amount of a specific compound present in a sample. Typically, a mass spectrometer performs this analysis by placing the molecules into an ionized state. Once the molecules are ionized, they may be controlled through the application of external electric and/or magnetic fields. The behavior of the ionized molecules can be recorded and analyzed in a variety of ways to determine their mass/charge ratios and the mass/charge ratios of the compounds formed from the fragmentation of the original molecules of the sample. From this mass/charge data, information relating to the formula, structure, isotopic ratio and amount of material present can be calculated or deduced.

The mass spectrometer itself is typically composed of several different components, often operating at different pressures and temperatures. A typical mass spectrometer includes an inlet or separation system within which the sample to be analyzed is separated into its fundamental chemical components prior to being mass analyzed. The separation device, typically a gas or liquid chromatograph, performs a chemical separation process and then directs the components of the sample into an ion source. The ion source is used to place the sample molecules into an ionized state whereupon the individually charged molecules may then be controlled through use of externally applied electric and/or magnetic fields.

After the ionized molecules leave the ion source they are directed into the analyzer, the dispersive element, whereby m/z ratios can be measured. This analysis step may involve the use of a single or multiple set of quadrupole rods, a magnetic and/or electric analyzer, a static or electrodynamic trapping device, an ion mobility cell, a time-of-flight measuring device, or any combination or concatenation of these and other analyzers.

In many mass spectrometer systems ionization occurs external to the mass spectrometer manifold. In these systems, the ionization event typically occurs at atmospheric, or near atmospheric, pressure. This places an additional requirement on the mass spectrometer which must transfer ions from a region of high pressure (atmosphere) to a region of low pressure inside the mass spectrometer analyzer and ion detector.

A system described in a patent by Wright (U.S. Pat. No. 8,796,616) utilized an ion guide placed in a separate vacuum manifold between a first inlet manifold and a third manifold that contained the mass spectrometer analyzer and ion detector. The vacuum chamber containing the ion guide in the Wright patent is pumped by a turbomolecular pump, or one port of a split flow turbomolecular pump, and is used to transport the inlet ion stream from the high pressure region of the first vacuum chamber to the lower pressure of the third vacuum chamber containing the analyzer and detector. A disadvantage of the Wright patent is that it requires the addition of a separate vacuum chamber containing a dedicated ion guide. For ion transmission for a portable, or handheld mass spectrometer, the dedicated ion guide adds additional size and weight to the mass spectrometer.

The development of portable mass spectrometers that can be taken into the field for direct sampling has required that several design criteria be met simultaneously. The mass spectrometer must have sufficient sensitivity to generate useful data, and yet be small and light enough to be easily transported.

An additional requirement for a portable mass spectrometer used in a field application is the ability to introduce a sample at atmospheric pressure. Normally, an atmospheric sample inlet for a mass spectrometer will be followed by several vacuum chambers inside the mass spectrometer, each pumped to successively lower pressures. A patent by Bier (U.S. Pat. No. 5,750,993) describes an atmospheric pressure ion source with a three-dimensional ion trap analyzer, in which two separate ion guides, in two separate vacuum chambers, are placed in series between the ion source inlet and the mass spectrometer analyzer.

This is the typical tradeoff in designing a portable mass spectrometer. Field sampling will normally require an inlet system that operates at atmospheric pressure, requiring significant pumping capacity to bring the sample inlet pressure down to the operating pressure of the mass spectrometer analyzer. With an increase in pumping capacity comes an increase in the size, weight, and power requirements of the pumping system. Likewise, the addition of an ion guide adds additional weight, size and power consumption. Therefore, for a mass spectrometer to be successful as a portable instrument, design choices made for the inlet and vacuum system are of critical importance.

### SUMMARY OF THE INVENTION

The invention describes several configurations that may be used by a portable, or handheld, mass spectrometer to achieve an efficient inlet sampling and vacuum pumping system.

One embodiment of the described invention uses an atmospheric ionization source in which the sample is ionized at atmospheric pressure and then transferred into the mass spectrometer for analysis. In this embodiment the mass spectrometer comprises two basic sections. The first section is used to collimate the injected ion beam into a narrow ion stream. The second section comprises the mass spectrometer analyzer and ion detector itself, in which the mass/charge ratio of the sampled ions are measured.

The first section of this embodiment comprises two ion funnels arranged in series, with each funnel contained within its own vacuum region. The use of two ion funnels operated in series permits the sampled ions to be focused into a narrow ion beam, even when operated at a pressure of several Torr.

The construction and operation of the ion funnel is well understood in the field of mass spectrometry and is described in detail in a patent by Smith (U.S. Pat. No. 6,107,628).

Many types of mass spectrometer analyzers may be used in a portable mass spectrometer, including a quadrupole mass filter, a magnetic sector mass spectrometer, a cylindrical ion trap, a quadrupole ion trap, a linear ion trap, a rectilinear ion trap, and a time-of-flight mass spectrometer. However, one of the best choices is to use an ion trap device, in particular a linear ion trap. The linear ion trap, often referred to as a two-dimensional ion trap, has a larger ion storage capacity than the three-dimensional quadrupole ion trap, and is capable of good performance when operating at pressures above 1 mill-Torr.

When using a linear ion trap for a mass spectrometer analyzer, optimal sensitivity is achieved when the ion trap is filled as efficiently as possible with sample ions. In normal operation of the linear ion trap, ions are injected into the center of the linear ion trap through one of the endcap electrodes. The most efficient injection of ions occurs when the sample ion beam is as narrow as possible and enters the linear ion trap analyzer at the very center of the ion trap longitudinal axis. However, injection efficiency will be compromised when the mass spectrometer operates at pressures in the milli-Torr region and the injected ions are dispersed due to random collisions with the neutral background molecules in the mass spectrometer inlet system.

A preferred embodiment of the invention is to collimate the ion bean through use of two ion funnels aligned serially along their longitudinal axis. In this manner, a highly collimated beam of ions will be generated from the outlet of the second ion funnel that will be capable of effectively filling the linear ion trap with sample ions prior to mass analysis.

In addition to the use of a dual ion funnel design, the invention describes the use of a lateral offset for the sample inlet stream, permitting an improvement in desolvation, and the removal of neutrals, excited state molecules, and particulates from flowing into the mass spectrometer analyzer.

### BRIEF DESCRIPTION OF THE DRAWINGS

FIG. 1 shows a basic outline of the mass spectrometer inlet system, comprising a first and second ion funnel chamber, followed by a chamber containing the mass spectrometer analyzer and ion detector. An atmospheric pressure ionization source is shown connected to the inlet aperture of the mass spectrometer.

FIG. 2 shows the basic mass spectrometer system plus an efficient pumping system involving a fore vacuum pump connected to the first ion funnel chamber, and a split-flow turbo molecular pump connected to both the second ion funnel chamber and the mass spectrometer analyzer chamber. The higher pumping capacity port of the split flow turbomolecular pump is connected to the third vacuum chamber containing the mass spectrometer analyzer. The low pumping capacity port of the split flow turbomolecular pump is connected to the second vacuum chamber containing the second ion funnel. Additionally, in the configuration shown, the fore vacuum pump is also used to back up the turbomolecular pump.

### DETAILED DESCRIPTION OF THE INVENTION

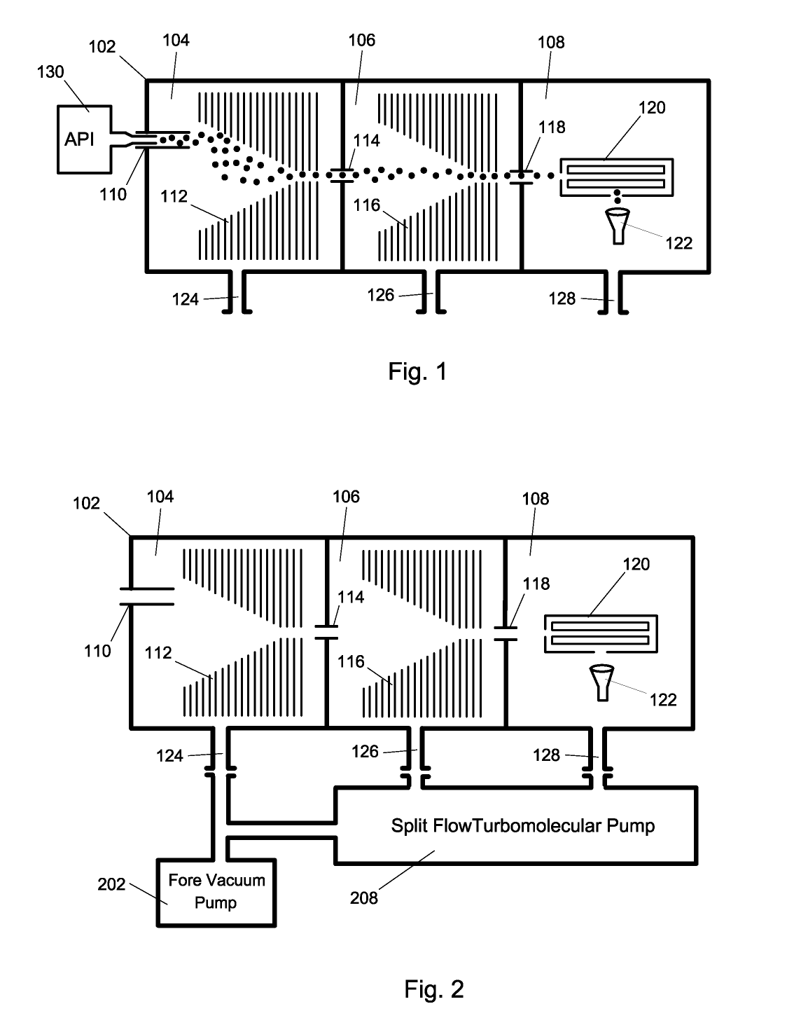

One embodiment of the invention is shown in FIG. 1. The mass spectrometer itself 102 comprises three separate vacuum chambers. The first vacuum chamber 104 is used to allow introduction of the sample into the instrument through inlet orifice 110. This first vacuum chamber contains an ion funnel 112. Sample ions are introduced into the instrument from an external ionization source 130 at 110 and are focused by the ion funnel 112 into a collimated stream of ions, which is then passed into the second vacuum chamber 106 through the aperture at 114, where the ions are again focused by ion funnel 116 and then passed through the aperture at 118 and into the third vacuum chamber 108 which contains the mass spectrometer analyzer 120 and ion detector 122.

The inlet orifice 110 for the externally generated ions is laterally offset from the axis of the first ion funnel 112. In this manner, metastable ions and other neutral or reactive species may be removed from the ion beam that is injected into the mass spectrometer. This is an important feature of the described invention, as the ionization and inlet system for a portable mass spectrometer will generally be as simple and uncomplicated as possible. Therefore, if the inlet from the atmospheric pressure ionization source has a direct, line-of-sight path from ion source to analyzer, there is an increased chance of contamination, or total blockage, of the small apertures 114 and 118, used to transfer sample ions through the mass spectrometer and into the analyzer. However, the use of a lateral offset for the inlet aperture 110 allows neutral particles, charged solvent clusters and particulates from the inlet stream to strike the focusing plates of the first ion funnel 112 and be pumped away by the fore vacuum pump connected to port 124.

After the sample ions have been collimated by the first ion funnel 112 and transferred into the second vacuum chamber 106, they pass into the second ion funnel 116 where they undergo additional focusing. The sample ions then pass out of the second ion funnel and through the aperture at 118 and into the third vacuum chamber 108. The third vacuum chamber 108 contains the mass spectrometer analyzer 120 and the ion detector 122. The mass spectrometer analyzer may be of several different types. The analyzer may be a quadrupole mass filter, a magnetic sector mass spectrometer, a cylindrical ion trap, a quadrupole ion trap, a linear ion trap, a rectilinear ion trap, or a time-of-flight mass spectrometer. In a preferred embodiment the mass spectrometer analyzer 120 comprises some sort of ion trapping device, due to the ability of ion trap mass spectrometers to operate effectively at relatively high pressures, such as between 0.1 to 10 milli-Torr.

If the mass spectrometer analyzer 120 is an ion trap, it may comprise any of several different types of ion traps. In one embodiment, the analyzer may be a three-dimensional ion trap comprising a hyperbolic ring electrode and two hyperbolic endcap electrodes. In another embodiment the analyzer may be a cylindrical ion trap, comprising a cylindrically shaped ring electrode and two flat endcap electrodes. In another embodiment the analyzer may comprise a linear ion trap, comprising four hyperbolic shaped rods and two endcap electrodes. In another embodiment the analyzer may be a rectilinear ion trap, comprising four planar electrodes and two planar endcaps. In another embodiment the linear ion trap may comprise four cylindrical rods and two endcaps.

In the embodiment comprising the linear ion trap analyzer, the endcaps may also be replaced with hyperbolic sections that confine the ions within the central region of the ion trap analyzer, as described in the patent by Bier (U.S. Pat. No. 5,420,425).

FIG. 2 illustrates one embodiment for the pumping system that may be used by the described invention. A single split-flow turbomolecular pump 208 may be used to pump both the second vacuum chamber 106 containing the second ion funnel 116 and the third vacuum chamber 108 containing the mass spectrometer analyzer 120 and the ion detector 122. In this embodiment, a single fore vacuum pump 202 is used to back up the split-flow turbomolecular pump 208 and also to pump the first vacuum chamber 104. In this configuration, the single fore vacuum pump is connected to the first vacuum chamber at port 124. The split flow turbomolecular pump is connected to the second ion funnel chamber at port 126 and is connected to the mass spectrometer analyzer chamber at port 128. The higher flow port is connected to the third vacuum chamber and the lower flow port is connected to the second vacuum chamber.

In another embodiment, one fore vacuum pump is connected to vacuum chamber one, a split flow turbomolecular pump is connected to vacuum chambers two and three, and a second fore vacuum pump is used to back up the turbomolecular pump.

In another embodiment, one fore vacuum pump is connected to the first vacuum chamber, and a turbomolecular pump is connected to the third vacuum chamber, and a second fore vacuum pump is connected to the second vacuum chamber and is also used to back up the turbomolecular pump.

In another embodiment, one fore vacuum pump is connected to vacuum chamber one, a second fore vacuum pump is connected to vacuum chamber two, and a turbomolecular pump is connected to vacuum chamber three. A third fore vacuum pump is used to back up the turbomolecular pump.

In another embodiment, a fore vacuum pump is connected to vacuum chamber one, and a turbomolecular pump is connected to vacuum chamber two. A second turbomolecular pump is connected to vacuum chamber three. A second fore vacuum pump is used to back up the first and second turbomolecular pumps.

In another embodiment a fore vacuum pump is connected to the first vacuum chamber. A turbomolecular pump is connected to the second vacuum chamber. A second turbomolecular pump is connected to the third vacuum chamber. A second fore vacuum pump is used to back up the first turbomolecular pump and a third fore vacuum pump is used to back up the second turbomolecular pump.

In another embodiment a fore vacuum pump is connected to the first vacuum chamber. A turbomolecular pump is connected to the second vacuum chamber, and a second turbomolecular pump is connected to the third vacuum chamber. The fore vacuum pump is also used to back up the turbomolecular pump. A second fore vacuum pump is used to backup the second turbomolecular pump.

The mass spectrometer device described here may successfully operate with different pressures within each vacuum chamber, depending primarily upon the type of mass spectrometer analyzer used. A quadrupole mass filter will typically require a vacuum pressure below 1 milli-Torr, while an ion trap mass spectrometer analyzer can operate at pressures of 0.1-10 milli-Torr and greater.

Additionally, the mass spectrometer described here can operate with different aperture sizes connecting the first ion funnel 112 to the second ion funnel 116, and the second ion funnel to the mass spectrometer analyzer 118. The inlet aperture 110 connecting the atmospheric pressure ionization source to the mass spectrometer manifold can have a varying aperture size. The inlet might be a continuous flow inlet, or it might be controlled through use of a controllable pinch valve, as used in a DAPI (Discontinuous Atmospheric Pressure Ionization) source.

For a typical mass spectrometer embodiment using a linear ion trap mass spectrometer analyzer, the system could be pumped with a split flow turbomolecular pump 208 rated at 60 Liters/second, backed up with a small rough pump 202 rated at 0.12 Liters/second, or greater. The atmospheric pressure ionization source would be operated at a pressure of 760 Torr. The first vacuum chamber 104 containing the first ion funnel 112 would typically be operated at a pressure of near atmosphere to 10⁻¹ Torr. The second vacuum chamber 106 containing the second ion funnel 116 would typically be operated at a pressure of approximately 10⁻¹ to 10⁻³ Torr. The third vacuum chamber containing the mass spectrometer analyzer would typically be operated at a pressure of approximately 10⁻³ to 10⁻⁵ Torr.

The aperture 110 connecting the atmospheric pressure ionization source 130 to the first vacuum manifold should typically be kept very small, due to the limited pumping capacity of the miniature vacuum system on the portable mass spectrometer. Additionally, the aperture 114 between the first vacuum region 104 and the second vacuum region 106 should be kept very small to limit the mass flow conductance from the primary vacuum stage into the secondary vacuum stage 106. Further, the aperture 118 connecting the second vacuum region 106 to the third vacuum region 108 should be kept very small to again limit the mass flow from the previous two stages into the third stage which contains the mass analyzer and ion detector. The inlet aperture for the atmospheric pressure ionization source 110 should have a diameter less than 0.3 mm, with a typical diameter of 0.12 mm. The aperture 114 between the first and second vacuum regions should have a diameter less than 2.5 mm, with a typical diameter of 1.2 mm. The aperture 118 between the second and third vacuum regions should have a diameter less than 2.5 mm, with a typical diameter of 1.2 mm.

A preferred embodiment of the invention requires use of a split flow turbomolecular pump. In this configuration, a fore vacuum pump 202 is used to back up the split flow turbomolecular pump and also to pump the first vacuum region 104 at vacuum port 124. The split flow turbomolecular pump is connected to the second and third vacuum regions at 126 and 128. A typical, small turbomolecular pump would be capable of providing a pumping rate of 60 Liters/second to the vacuum port 128 for the third vacuum region 108, and 9 Liters/second to the vacuum port 126 for the second vacuum region 106.

Although the implementation of the ion funnel is a well understood technology in the field of mass spectrometry, and described in detail in the Smith patent (U.S. Pat. No. 6,107,628), there are still a number of design variables that can be selected, depending upon the specific implementation. For the type of portable mass spectrometer system described here, a typical embodiment for each of the two ion funnels would have an inlet diameter of 20 to 25 mm, an outlet diameter of 2 to 3 mm or greater, and a length of 60 to 80 mm or less. The geometry of each of the two ion funnels would have apertures, through which gas could escape, comprising an area significantly greater than 10 cm².

While many variations of vacuum systems may be employed, it must be realized that a critical design goal of a portable mass spectrometer involves the reduction of size and weight to permit the final mass spectrometer to be easily transported, have minimal complexity and low power consumption. Therefore, while many pumping configurations are possible, the optimum configuration would comprise a single split flow turbomolecular pump and a single fore vacuum pump.

1. A portable mass spectrometer comprising:
three differentially pumped vacuum chambers;
an inlet port in the first of said vacuum chambers to receive ionized sample molecules;
an ion funnel installed in said first vacuum chamber to focus said ionized sample molecules;
a connecting aperture between said first vacuum chamber and said second vacuum chamber to transfer said focused ionized sample molecules into said second vacuum chamber;
an ion funnel installed in said second vacuum chamber to focus said sample molecules;
a connecting aperture between said second vacuum chamber and said third vacuum chamber to transfer said sample molecules into said third vacuum chamber;
a mass spectrometer analyzer and ion detector installed in said third vacuum chamber to detect and identify the mass/charge ratios of said sample molecules.

2. The portable mass spectrometer of claim 1 in which the mass spectrometer analyzer is selected from the group consisting of a quadrupole mass filter, a magnetic sector mass spectrometer, a cylindrical ion trap, a quadrupole ion trap, a linear ion trap, a rectilinear ion trap, and a time-of-flight mass spectrometer.

3. The portable mass spectrometer of claim 1 in which said first vacuum chamber is operated at a pressure of near atmosphere to 10⁻¹ Torr.

4. The portable mass spectrometer of claim 1 in which said second vacuum chamber is operated at a pressure of 10⁻¹ to 10⁻³ Torr.

5. The portable mass spectrometer of claim 1 in which said third vacuum chamber containing said mass spectrometer analyzer and said ion detector is operated at a pressure of 10⁻³ to 10⁻⁵ Torr.

6. The portable mass spectrometer of claim 1 in which a split flow turbomolecular pump high vacuum port is connected to said third vacuum chamber and said split flow turbomolecular pump low vacuum port is connected to said second vacuum chamber and a fore vacuum pump is connected to said first vacuum chamber, and said fore vacuum pump is used to back up said split flow turbomolecular pump.

7. The portable mass spectrometer of claim 1 in which a split flow turbomolecular pump high vacuum port is connected to said third vacuum chamber and said split flow turbomolecular pump low vacuum port is connected to said second vacuum chamber and a fore vacuum pump is connected to said first vacuum chamber and a second fore vacuum pump is used to back up said split flow turbo molecular pump.

8. The portable mass spectrometer of claim 1 in which a fore vacuum pump is connected to said first vacuum chamber, and a second fore vacuum pump is connected to said second vacuum chamber and a turbomolecular pump is connected to said third vacuum chamber, and said second fore vacuum pump is used to back up said turbomolecular pump.

9. The portable mass spectrometer of claim 1 in which a fore vacuum pump is connected to said first vacuum chamber, and a second fore vacuum pump is connected to said second vacuum chamber, and a turbomolecular pump is connected to said third vacuum chamber and a third fore vacuum pump is used to back up said turbomolecular pump.

10. The portable mass spectrometer of claim 1 in which a fore vacuum pump is connected to said first vacuum chamber, and a turbomolecular pump is connected to said second vacuum chamber, and a second turbomolecular pump is connected to said third vacuum chamber and a second fore vacuum pump is used to backup both said turbomolecular pump and said second turbomolecular pump.

11. The portable mass spectrometer of claim 1 in which a fore vacuum pump is connected to said first vacuum chamber, and a turbomolecular pump is connected to said second vacuum chamber and a second turbomolecular pump is connected to said third vacuum chamber, and a second fore vacuum pump is used to back up said turbomolecular pump and a third fore vacuum pump is used to back up said second turbomolecular pump.

12. The portable mass spectrometer of claim 1 in which a fore vacuum pump is connected to said first vacuum chamber, and a turbomolecular pump is connected to said second vacuum chamber and a second turbomolecular pump is connected to said third vacuum chamber and said fore vacuum pump is also used to back up said turbomolecular pump, and a second fore vacuum pump is used to back up said second turbomolecular pump.

13. The method of reducing the transmission of neutrals, excited state molecules and particulates from entering the mass analyzer of a portable mass spectrometer by incorporating a lateral offset into the input aperture from the longitudinal axis of the first focusing ion funnel.

14. The method by which a portable mass spectrometer may reduce size and weight and improve sample ion transmission efficiency by utilizing ion funnels in place of ion guides.
